(19) United States
(12) Patent Application Publication
(10) Pub. No.: US 2026/0117082 A1
(43) Pub. Date: Apr. 30, 2026

(54) DIGITAL PRINTING METHOD FOR MICROENCAPSULATED FRAGRANCE PRODUCT

(71) Applicant: Kenneth F. Flower, Fremont, OH (US)

(72) Inventor: Kenneth F. Flower, Fremont, OH (US)

(21) Appl. No.: 19/373,978

(22) Filed: Oct. 30, 2025

Related U.S. Application Data
(60) Provisional application No. 63/713,863, filed on Oct. 30, 2024.

(51) Int. Cl. C09D 11/30; B01J 13/12; B41J 2/14; B41M 3/00; B41M 7/00

(52) U.S. Cl. CPC C09D 11/30; B01J 13/125; B41J 2/1433; B41M 3/006; B41M 3/008; B41M 7/0081; B41M 7/009

(57) ABSTRACT

The present disclosure provides a method for digitally manufacturing a scratch and sniff portion on a substrate with microencapsulated fragrance varnish and the resulting scratch and sniff product. The method can include steps of printing a base image on a substrate using a digital ink and identifying the scratch and sniff portion on the substrate for application of the microencapsulated fragrance varnish. The method can further include applying the microencapsulated fragrance varnish to the scratch and sniff portion on the substrate using a digital printing process with a large orifice print head. The microencapsulated fragrance varnish can require physical activation to release the fragrance.

### CROSS-REFERENCE TO RELATED APPLICATIONS

This application claims the benefit of U.S. Provisional Application No. 63/713,863, filed on Oct. 30, 2024. The entire disclosure of the above application is incorporated herein by reference.

### FIELD

The present technology relates to a digital printing method for a fragrance product, and more particularly, to a method for digitally manufacturing a microencapsulated fragrance product.

### INTRODUCTION

This section provides background information related to the present disclosure which is not necessarily prior art.

Scratch-and-sniff technology emerged in the 1960s as a method to enhance printed material with scent, allowing a user to experience fragrance by scratching a coated area on a medium such as paper or a label. The technology found applications in advertising, marketing, educational materials, and greeting cards. The concept of integrating scent into printed media gained traction in the 1970s, with companies experimenting with microencapsulation techniques that involved encapsulating fragrance in a polymer microsphere that releases scent upon physical activation.

The manufacturing process for scratch-and-sniff products involves several steps. A fragrance can be microencapsulated in a polymer microsphere to protect the scent from evaporation and degradation. The microcapsule can then be mixed with a binding agent and applied onto a substrate using printing techniques such as offset or flexographic printing. After printing, the material is dried and cured to ensure that the microcapsule adheres properly to the substrate.

Offset printing faces challenges that limit effectiveness for scratch-and-sniff production. The process requires specialized plates and equipment, making offset printing less economical for small print runs. The initial setup can be time-consuming, as preparing the press including making plates and calibrating the machine takes considerable time, particularly for complex designs. Offset printing also has limitations in substrate compatibility, as it works optimally on smooth surfaces, which may restrict options for certain scratch-and-sniff applications.

Flexographic printing, while generally faster than offset printing, encounters a different set of challenges. The cost of flexo-plates, although less than offset plates, still requires a significant investment, particularly for high-quality printing. Achieving high-quality results can require careful calibration, which may slow down production if adjustment is needed. Flexographic printing can also struggle with certain color applications, which might require additional passes or adjustments to achieve the desired outcome.

Silk screen printing presents additional challenges for scratch-and-sniff production that further limit viability for efficient manufacturing. The silk screen process requires the creation of custom screens for each design element, resulting in significant setup costs and time investment that make small-batch production economically unfeasible. The mesh density required for adequate ink coverage can become clogged when printing microencapsulated fragrance materials, leading to uneven application and potential production delays. Additionally, silk screen printing can require multiple passes to achieve adequate ink density for fragrance release, increasing production time and labor costs. The manual nature of much silk screen printing equipment limits automation possibilities and creates consistency challenges across production runs.

Offset, flexographic, and silk screen printing methods present barriers to cost-effective, small-batch production of scratch-and-sniff products. The high setup costs and time-consuming preparation processes make these methods less suitable for customized or on-demand production. The limitations in substrate compatibility and the complexity of achieving consistent quality further compound these challenges.

Accordingly, there is a continuing need for a versatile and cost-efficient method for printing microencapsulated fragrance to create scratch and sniff products that can accommodate small batch production and provide greater flexibility in customization and substrate selection.

### SUMMARY

In concordance with the instant disclosure, a versatile and cost-efficient method for printing microencapsulated fragrance to create scratch and sniff products that can accommodate small batch production and provide greater flexibility in customization and substrate selection, has surprisingly been discovered. The present technology includes articles of manufacture, systems, and processes that relate to a digital printing method for creating a microencapsulated fragrance product, and more particularly to a system and method for manufacturing a scratch and sniff product using a large orifice print head to apply fragrance-containing varnishes to substrates.

In certain embodiments, a scratch and sniff product is provided. The scratch and sniff product can include a substrate, a base image, and a microencapsulated fragrance varnish. The base image can be digitally printed on the substrate using a digital ink. The microencapsulated fragrance varnish can be applied to a scratch and sniff portion on the substrate using a digital printing process with a large orifice print head. The microencapsulated fragrance varnish can require physical activation to release a fragrance.

In certain embodiments, a method for digitally manufacturing a scratch and sniff portion on a substrate with microencapsulated fragrance varnish is provided. The method can include steps of printing a base image on a substrate using a digital ink and identifying the scratch and sniff portion on the substrate for application of the microencapsulated fragrance varnish. The method can further include applying the microencapsulated fragrance varnish to the scratch and sniff portion on the substrate using a digital printing process with a large orifice print head. The microencapsulated fragrance varnish can require physical activation to release the fragrance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a schematic depicting aspects of a scratch and sniff product, accordingly to one embodiment;

FIG. 1B is a schematic depicting aspects of a scratch and sniff product, accordingly to another embodiment;

FIG. 2 is a top plan view of an embodiment of the scratch and sniff product with a base image digitally printed;

FIG. 3 is a top plan view of an embodiment of the scratch and sniff product with a microencapsulated fragrance varnish disposed on the base image;

FIG. 4 is a top plan view of an embodiment of the scratch and sniff product with a microencapsulated fragrance varnish overlapping a portion of the base image;

FIG. 5 is a top plan view of an embodiment of the scratch and sniff product with a microencapsulated fragrance varnish spaced apart from the base image;

FIG. 6 is a top plan view of an embodiment of the scratch and sniff product with a first scratch and sniff portion and a second scratch and sniff portion;

FIG. 7 is a top plan view of an embodiment of the scratch and sniff product with a microencapsulated fragrance varnish printed in the base image; and

FIGS. 8A-8C provide a flowchart depicting a method for digitally manufacturing the scratch and sniff product having a scratch and sniff portion on a substrate with a microencapsulated fragrance varnish.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, “varnish” can refer to any printable coating composition, fluid medium, or marking material that can be applied to a substrate through a printing process, including but not limited to clear protective varnishes, colored varnishes, aqueous varnishes, UV-curable varnishes, solvent-based varnishes, water-based inks, solvent-based inks, UV-curable inks, LED-curable inks, pigmented inks, dye-based inks, toners (both dry and liquid), and any other printable formulations regardless of opacity, color, or functional properties. The term “varnish” encompasses both transparent and opaque compositions, including those that provide protective, decorative, or functional characteristics to the printed substrate. The “varnish” can contain various additives, particles, or encapsulated materials while maintaining printability through printing equipment, and includes formulations with viscosities ranging from low-viscosity inks suitable for standard print heads to higher-viscosity materials.

As used herein, “printing process” can refer to any method, technique, or system for depositing, applying, or transferring printable materials onto a substrate, including but not limited to digital printing processes, inkjet printing, laser printing, xerographic printing, electrophotographic printing, copier-based printing, thermal printing, and any variation or combination thereof. The printing process can encompass the capability to produce printed elements of any size, shape, configuration, text content, graphic design, color scheme, or visual presentation, wherein the microencapsulated fragrance varnish or other fragrance-containing materials can be incorporated as part of the overall printed composition. The printing process can include selective application to particular areas of the substrate, specific textual elements, designated graphic regions, or precisely defined coordinates, allowing for targeted placement of fragrance-containing materials in predetermined locations relative to base images, text, or other printed content. This includes the ability to print fragrance materials over existing printed elements, adjacent to printed content, or in spatially separate areas, providing flexibility in creating interactive olfactory experiences that correspond to specific visual elements or designated activation zones.

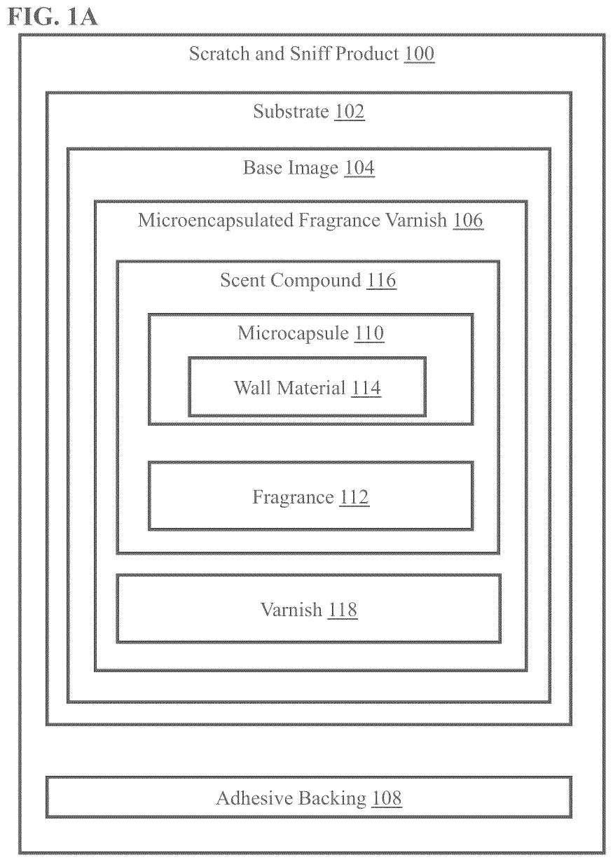

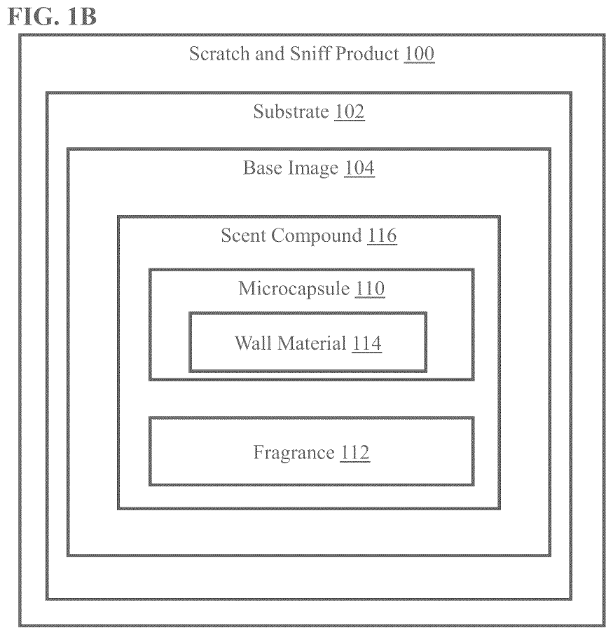

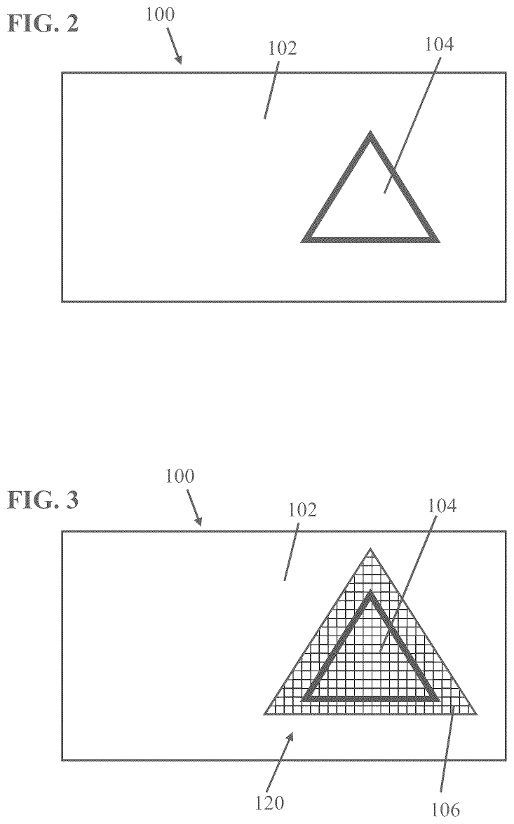

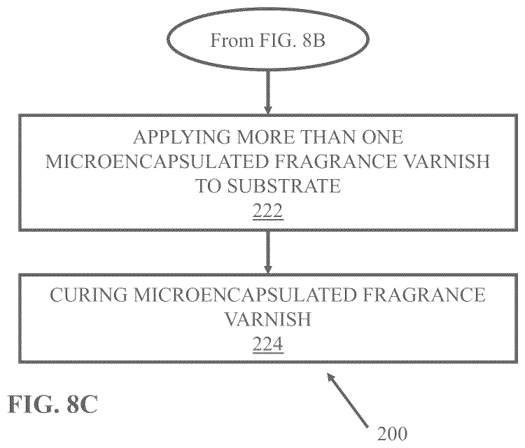

The present disclosure provides a scratch and sniff product 100 (e.g., FIGS. 1-5) formed using a digital manufacturing method 200 (e.g., FIGS. 8A-8C). The digital manufacturing method 200 can overcome limitations of certain printing methods that require expensive plate preparation, lengthy setup times, and high minimum order quantities that make small batch production economically unfeasible. The method 200 can enable cost-effective, on-demand production of a customized scratch and sniff product with greater flexibility in substrate selection and design customization. The resulting scratch and sniff product 100 can provide an enhanced user experience through precisely controlled fragrance release, while offering a manufacturer the ability to economically produce small quantities and respond quickly to market demands for personalized or limited-edition scented materials. The scratch and sniff product 100 can include a substrate 102, a base image 104, and a microencapsulated fragrance varnish 106. It should be noted that the microencapsulated fragrance varnish 106 is denoted by the patterned portion depicted in FIGS. 3-5.

The substrate 102, the base image 104, and the microencapsulated fragrance varnish 106 can be layered as described herein to produce the scratch and sniff product 100. The substrate 102 can serve as a primary layer for the scratch and sniff product 100 and can be selected from paper, cardstock, plastic, plastic film, or fabric, for example, depending on the intended application and performance requirements. In certain embodiments, the substrate 102 can have a basis weight from 60 grams to 350 grams per square meter to accommodate various product applications from lightweight promotional materials to heavy-duty packaging. A skilled artisan can select a suitable substrate 102 within the scope of the present disclosure.

The substrate 102 can provide a stable printing surface that supports both the base image 104 and the microencapsulated fragrance varnish 106 while maintaining structural integrity throughout the manufacturing and use processes. The substrate 102 can be engineered to withstand the digital printing process, including exposure to digital ink and the application of microencapsulated fragrance varnish 106 through a print head, without warping, bleeding, or degrading. The substrate 102 can also endure the physical activation process, where a user scratches or rubs the scratch and sniff product 100 to release the fragrance, requiring sufficient durability to militate against tearing or excessive wear during normal use. The substrate 102 can have a thickness that provides adequate strength to withstand both the printing process and the scratching action without compromising the underlying structure or the fragrance release mechanism. A skilled artisan can select a suitable thickness of the substrate 102 to withstand the physical activation process required by the scratch and sniff product 100 within the scope of the present disclosure.

In certain embodiments, the substrate 102 can include an adhesive backing 108 that allows the scratch and sniff product 100 to function as a sticker, enabling application to various surfaces such as packaging, promotional materials, or personal items. The adhesive backing 108 can include a removable layer, such as a wax paper layer, that protects the adhesive backing 108 until use, allowing the user to choose when to apply the sticker while maintaining the effectiveness of the adhesive and militating against contamination during storage and handling.

The base image 104 can be printed onto the substrate 102 using ink suitable for digital printing, which can provide precise control over image quality, color accuracy, and placement. Digital printing can enable on-demand printing, cost-effective small batch production, and rapid customization of the base image to meet specific requirements or marketing objectives. The ink during the digital printing process can be a low odor ink to avoid interference with the fragrance experience of the scratch and sniff product 100, ensuring that the olfactory component of the scratch and sniff product 100 remains uncompromised by competing scents from the printing process. For example, the low odor ink can include a low volatile organic compound (VOC) ink configured to release substantially lower compounds into the atmosphere resulting in less odor. The ink can be an inkjet ink, UV curable ink, or LED curable ink, for example. A skilled artisan can select a suitable ink within the scope of the present disclosure.

The base image 104 can include text, a graphic, a logo, or visual content that enhances the overall product and communicates information to the user. The base image 104 can be printed in black and white or color, providing flexibility to match brand requirements, aesthetic preferences, or cost considerations. The base image 104 can be any shape and size, limited only by the dimensions of the substrate 102 and the capabilities of the digital printing equipment, allowing for creative designs that can range from simple geometric patterns to complex photographic reproductions. The base image 104 can serve multiple functions, including providing visual appeal, conveying product information, establishing brand identity, or creating thematic connections with the associated fragrance. Examples include where the base image 104 includes graphics, text, and/or other indicia and where the base image 104 includes a single color or is multicolored. The base image 104 can work in conjunction with the scratch and sniff product 100, where visual elements can guide the user to the scented area or create anticipation for the olfactory experience that will be released upon activation.

It should be appreciated that the microencapsulated fragrance varnish 106 can include a clear varnish containing a microcapsule 110 that encapsulates a fragrance 112 within a wall material 114. Examples further include where the microencapsulated fragrance varnish 106 ranges from almost completely transparent to tinted or translucent in appearance, allowing at least some degree of light transmission and allowing the base image 104 to be viewed therethrough. The fragrance 112 within the microcapsule 110 can correspond to a desired scent. The wall material 114 can contain the fragrance 112 and militate against the desired scent from being prematurely released. The wall material 114 can be formed from a polymer selected from gelatin, alginate, modified starch, or combinations thereof, for example. A skilled artisan can select a suitable wall material 114 within the scope of the present disclosure. The encapsulation wall material can form a protective barrier around the fragrance, preventing evaporation and degradation while maintaining the integrity of the scent until activation occurs. It should be appreciated that activation of the microcapsule 110 to release the fragrance 112 can include various forms of mechanical action that can cause the wall material 114 of the microcapsule 110 to breach and release the encapsulated fragrance 112. Physical activation can include direct contact methods such as scratching or rubbing the scratch and sniff portion 120. The activation mechanism can also include other forms of physical agitation that can generate sufficient force to compromise the structural integrity of the encapsulation wall material 114, including ripping, tearing, or other manipulative actions that can be applied to the substrate 102 containing the microencapsulated fragrance varnish 106.

In certain embodiments, the microcapsule 110 can have a diameter from about 1 micron to about 50 microns, providing a balance between fragrance retention and release characteristics. In a particular embodiment, the microcapsule 110 can have a diameter from about 20 microns to about 30 microns. A skilled artisan can select a suitable diameter for the microcapsule 110 within the scope of the present disclosure.

The microencapsulated fragrance varnish 106 can be prepared by a mixing scent compound 116 containing the microcapsule 110 with a clear varnish 118 to form a homogeneous mixture. The scent compound 116 can be created through a process where the fragrance 112 is emulsified in a solution containing the wall material using high-shear mixing to create a stable emulsion, followed by solidifying the microcapsule 110 through spray drying, freeze-drying, or solvent evaporation to form the scent compound. The scent compound 116 can then be mixed into the varnish 118 using a power mixer. In certain embodiments, the power mixer can have speeds ranging from about 200 rpm to about 1000 rpm, which can include a tabletop mixer, a hand drill, or a blade and mixer, for example. A skilled artisan can select a suitable mixing means within the scope of the present disclosure. The mixing process can create a smooth homogeneous mixture with no agglomerations, ensuring consistent application during the digital printing process.

The microencapsulated fragrance varnish 106 can be applied to the substrate 102 using a digital printing process with a large orifice print head. The varnish 118 can have a viscosity from about 100 centipoise to about 10,000 centipoise, making the varnish 118 suitable for digital printing applications. The large orifice print head can apply the microencapsulated fragrance varnish 106 at a resolution from about 150 dots per inch to about 600 dots per inch, providing adequate coverage while maintaining print quality. The microencapsulated fragrance varnish 106 can be transparent when applied to the substrate 102, allowing an underlying graphic or text to remain visible while providing the scratch and sniff functionality.

The microencapsulated fragrance varnish 106 can require physical activation to release the fragrance 112, creating an interactive element that engages the user through both tactile and olfactory senses. When the user scratches or rubs the area of the scratch and sniff product 100 containing the microencapsulated fragrance varnish 106, the microcapsule 110 can rupture, releasing the encapsulated fragrance 112 and creating the desired olfactory experience. The physical activation mechanism can ensure that the fragrance 112 is released only when intended, militating against premature scent loss during storage and handling.

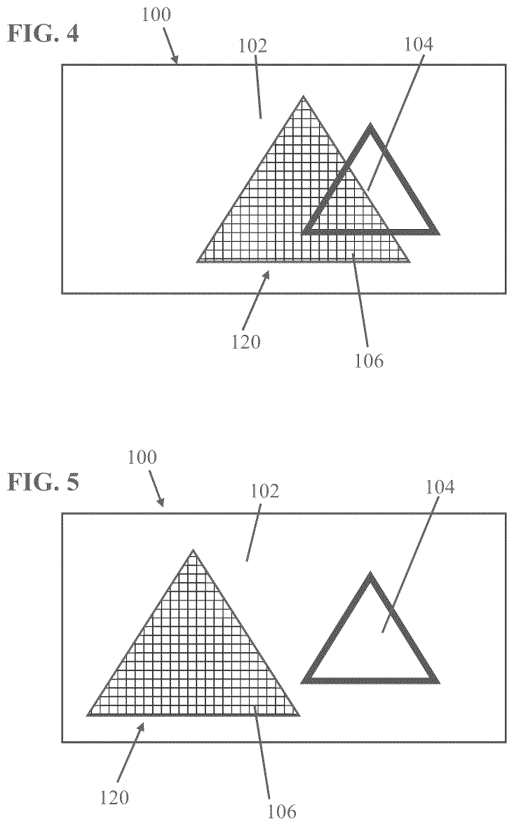

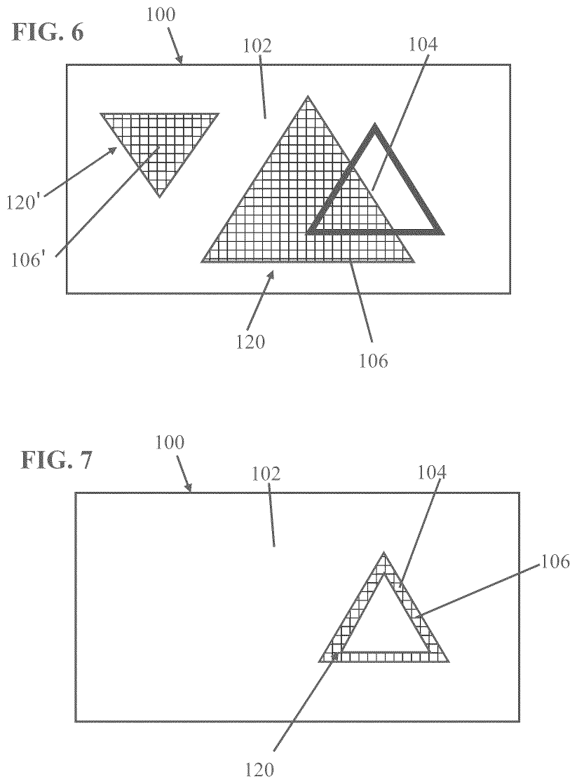

The microencapsulated fragrance varnish 106 can be applied to only a portion of the substrate 102, creating a designated scratch and sniff portion 120 that can be positioned in various configurations relative to the base image 104. The scratch and sniff portion 120 can overlap with a portion of the base image 104, allowing the fragrance from the fragrance 112 to be associated with a specific visual element and creating a direct connection between the visual and olfactory experiences, as shown in FIG. 4. Alternatively, the scratch and sniff portion 120 can entirely cover the base image 104, creating a unified scented area where the entire visual content becomes interactive and scented, as shown in FIG. 3. In another configuration shown in FIG. 5, the scratch and sniff portion 120 can be spaced apart from the base image 104, providing distinct visual and olfactory zones on the substrate that allow for separate messaging or branding opportunities.

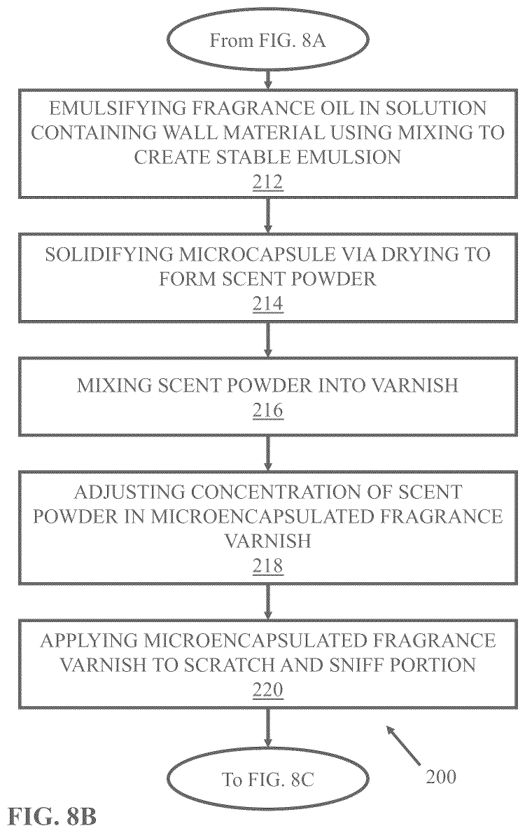

In certain embodiments, the base image 104 can include the scent compound 116 integrated directly within the ink composition, such that the base image 104 can printed with both visual and olfactory elements combined in a single printing process, as shown in FIG. 7. The integrated approach allows the fragrance 112 to be incorporated into the ink formulation itself, creating a dual-function printing material that simultaneously delivers graphic content and scent release capability without requiring separate application steps. The scent-enhanced base image 104 can be formulated by mixing the microcapsule 110 having the fragrance 112 directly into the ink during preparation, ensuring that a text, a graphic, a logo, or other visual elements carry embedded fragrance that releases upon physical activation of the printed surface. In certain embodiments in which the base image 104 includes the scent compound 116 the base image 104 can function as the scratch and sniff portion 120, where the user can activate fragrance release by scratching or rubbing any portion of the printed graphic content, creating a unified sensory experience that militates against the need for separate scratch and sniff portions 120. The integrated printing approach provides enhanced design flexibility by allowing the manufacturer to create a scratch and sniff product 100 where a specific textual element, an individual graphic component, or an entire image serves as both a visual communication tool and interactive fragrance delivery system.

The microencapsulated fragrance varnish 106 can maintain fragrance release capability for about six months under ambient storage conditions, providing long-term functionality and shelf stability that makes the product suitable for commercial applications with extended distribution and storage periods. The scratch and sniff portion 120 can include multiple layers of microencapsulated fragrance varnish 118 to enhance fragrance intensity or longevity, allowing for stronger scent release or extended use over time. After application, the microencapsulated fragrance varnish 106 can be cured using heat, UV light, or air drying to ensure proper adhesion to the substrate and optimal microcapsule stability, for example. A skilled artisan can select a suitable drying technique within the scope of the present disclosure.

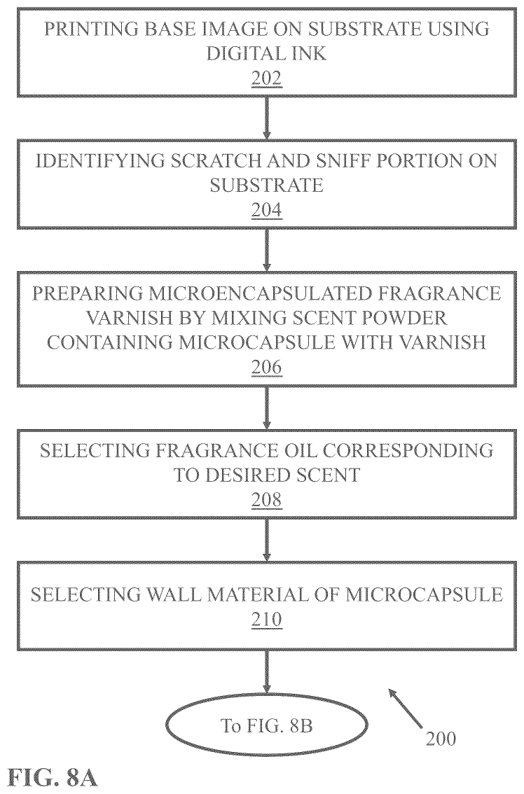

In certain embodiments, more than one fragrance 112 can be used to create a mixture of scents within a single microencapsulated fragrance varnish 106, allowing for complex olfactory profiles that can provide layered or blended fragrance experiences. The multiple fragrances 112 can be combined during the emulsification process to create a unified scent profile, or can be separately encapsulated and then mixed together in the varnish to maintain distinct scent characteristics that release simultaneously upon activation. In another embodiment shown in FIG. 6, the scratch and sniff product 100 can include a first scratch and sniff portion 120 containing a first microencapsulated fragrance varnish 106 and a second scratch and sniff portion 120′ containing a second microencapsulated fragrance varnish 106′, enabling the user to experience different fragrances from different areas of the same substrate 102. Alternatively, the scents can be layered within the same scratch and sniff portion 120, where multiple layers of microencapsulated fragrance varnish containing different scents can be applied sequentially, creating a multi-dimensional olfactory experience where different scents can be released through varying degrees of scratching or rubbing intensity. The layered approach can enable the creation of fragrance narratives where an initial light scratching releases a first scent, and more vigorous activation releases additional underlying scents, providing an evolving olfactory experience that can enhance user engagement and product memorability.

Digital printing can operate by depositing ink or other materials onto a substrate through controlled ejection from a print head, without requiring physical contact between the printing mechanism and the surface of the substrate 102. The digital printing process can utilize data from digital files to precisely control where and how much material is deposited at each location, enabling variable content and customization within a single print run. Certain digital print heads can include small orifices for ink that does not include microencapsulated fragrance varnish 106, which have low viscosity and contain no solid particles that could clog the printing mechanism. The digital printing process can provide advantages including rapid setup, precise registration, and the ability to change content between printed pieces without stopping production.

As utilized by the method 200 herein, the large orifice print head can differ significantly from other print heads by incorporating openings that are substantially larger than those found in digital printing equipment, which include a printer head orifice printing opening of about 10 microns. In other words, the large orifice print head can be at least 5 microns larger than a commercial orifice print head. The large orifice print head can include an opening from about 15 microns to about 55 microns in diameter, and in a particular embodiment, approximately 20 microns in diameter, which can be several times larger than other inkjet nozzles. The enlarged orifice can accommodate material that contains solid particles or has a higher viscosity than certain printing inks, while still maintaining the precision and control characteristics required for digital printing applications. The large orifice can reduce or militate against clogging that would occur if the microcapsule 110 was forced through a smaller nozzle, ensuring consistent material flow and reliable printing performance.

The large orifice print head can accommodate the microencapsulated fragrance varnish 106 by providing sufficient clearance for the microcapsules 110 to pass through the printing mechanism without rupturing or causing blockages. As described herein, the microcapsules 110 can have a diameter from about 1 micron to about 50 microns, and the large orifice opening can be sized to allow the largest anticipated microcapsules 110 to flow freely while maintaining printing accuracy. The large orifice can enable the controlled deposition of the microencapsulated fragrance varnish 106 containing intact microcapsules 110 onto the substrate 102, preserving the encapsulation integrity that is required for optimal fragrance release upon activation.

The specifications of the large orifice print head can include not only the enlarged opening diameter but also modified internal flow paths, pressure control systems, and material compatibility features that enable successful printing with particle-laden varnishes. The large orifice print head can be constructed from a material that resists chemical interaction with the fragrances 112 and varnish 118 components, militating against degradation or contamination that could affect print quality or fragrance integrity. The large orifice print head can incorporate pressure regulation mechanisms that can accommodate the higher viscosity of the microencapsulated fragrance varnish while maintaining consistent droplet formation and placement accuracy. The large orifice print head can apply the microencapsulated fragrance varnish at a resolution between about 150 dots per inch and about 600 dots per inch, providing adequate coverage for effective scratch and sniff functionality while maintaining sufficient precision for accurate placement relative to the base image 104.

The large orifice print head can enable digital printing at varied speeds when applying the microencapsulated fragrance varnish 106, allowing for efficient production while ensuring that the microcapsules are not subjected to excessive mechanical stress that could cause premature rupture. The large orifice print head can minimize shear forces on the microcapsule 110 during the printing process, preserving the structural integrity of the microcapsule 110 until the intended activation by the end user. The printing system can incorporate temperature control to maintain optimal varnish viscosity during printing, and can include a cleaning mechanism to handle the particle-containing varnish without damaging the large orifice opening.

The present disclosure further provides a method 200 for digitally manufacturing the scratch and sniff product 100 having the scratch and sniff portion 120 on the substrate 102 with microencapsulated fragrance varnish 106, as shown generally in FIGS. 8A-8C. The method 200 can be utilized to produce the scratch and sniff product 100 as described herein. The method 200 can include a step 202 of printing the base image 104 on the substrate 102 using an ink suitable for a digital printing process.

The method 200 can include a step 204 of identifying the scratch and sniff portion 120 on the substrate 102 for application of the microencapsulated fragrance varnish 106. As described herein, the scratch and sniff portion 120 can be positioned in various configurations relative to the base image 104. The scratch and sniff portion 120 can overlap with a portion of the base image 104, allowing the fragrance to be associated with a specific visual element. Alternatively, the scratch and sniff portion 120 can entirely cover the base image 104, creating a unified scented area. In another implementation, the scratch and sniff portion 120 can be spaced apart from the base image 104, providing distinct visual and olfactory zones on the substrate. The step 204 of identifying the scratch and sniff portion 120 can include receiving digital artwork data specifying coordinates for the scratch and sniff portion 120, enabling precise placement and automated production.

The method 200 can include a step 206 of preparing the microencapsulated fragrance varnish 106 by mixing the scent compound 116 containing the microcapsule 110 with the clear varnish 118 to form the homogeneous mixture. The step of preparing the microencapsulated fragrance varnish 106 can include further steps including a step 208 of selecting the fragrance 112 corresponding to a desired scent. The desired scent can be selected based on the preference of the user or the desired scent can be selected to correspond with the base image 104. The wall material 114 of the microcapsule 110 can also be selected in a step 210. As described herein, the wall material 114 can include a polymer selected from gelatin, alginate, modified starch, or combinations thereof, for example. In a step 212, the method 200 can include emulsifying the fragrance 112 in a solution containing the wall material 114 using mixing to create a stable emulsion. The microcapsule 110 can be solidified via drying to form the scent compound 116 in a step 214. It should be appreciated that the solidifying step 214 can be accomplished through spray drying, freeze-drying, or solvent evaporation. In a step 216, the method 200 can include mixing the scent compound 116 into varnish 118 to form the microencapsulated fragrance varnish 106.

It should be appreciated that the concentration of a scent compound 116 in the microencapsulated fragrance varnish 106 can be adjusted to control an intensity of the released fragrance, in a step 218. The concentration of scent compound 116 in the microencapsulated fragrance varnish 106 can be adjusted to control the intensity of the released fragrance, providing precise customization of the olfactory experience based on specific requirements or user preferences. A higher concentration of scent compound 116 can result in a stronger fragrance release when the microcapsule 110 are activated, creating a more pronounced and noticeable scent that can be suitable for applications requiring immediate impact or long-distance detection. Conversely, a lower concentration of scent compound 116 can produce a more subtle fragrance release that provides a gentle olfactory experience without overwhelming the user, which can be appropriate for products intended for close-range interaction or sensitive applications. The ability to adjust the concentration can enable manufacturers to tailor the fragrance strength to match the intended use case, whether for bold marketing materials that require attention-grabbing scents, educational products that need moderate fragrance levels, or luxury applications that benefit from refined and delicate scent profiles. The concentration control can also allow for consistency across production batches, ensuring that each scratch and sniff product 100 delivers the expected fragrance intensity and user experience.

The method 200 can include a step 220 of applying the microencapsulated fragrance varnish 106 to the scratch and sniff portion 120 using the digital printing process utilizing the large orifice print head. As described herein, the large orifice print head can comprise an opening from about 15 microns to about 25 microns in diameter, and in a particular embodiment, approximately 20 microns in diameter. The larger opening size can accommodate a microcapsule 110 within the microencapsulated fragrance varnish 106 while maintaining printing precision. The digital printing process can operate at a printing speed from about 10 feet per minute to about 100 feet per minute, enabling efficient production. The large orifice print head can apply the microencapsulated fragrance varnish 106 at a resolution from about 150 dots per inch to about 600 dots per inch, providing adequate coverage while maintaining print quality.

In certain embodiments, the method 200 can include a step 222 of applying more than one microencapsulated fragrance varnish 106 to the substrate 102, where each microencapsulated fragrance varnish 106 can have a different scent to create a multi-fragrance product experience. Each different microencapsulated fragrance varnish 106 can be applied to a separate scratch and sniff portion 120 on the substrate 102, allowing the user to experience distinct fragrances from different areas of the same product. The microencapsulated fragrance varnishes 106 can be applied sequentially using the large orifice print head, with each application targeting a specific location identified through digital artwork data that specifies coordinates for each individual scratch and sniff portion. The multi-scent approach can enable the creation of complex olfactory narratives, themed fragrance collections, or educational products that associate different scents with corresponding visual elements. The method 200 can accommodate any number of different microencapsulated fragrance varnishes within the practical constraints of the substrate 102 size and printing capabilities, allowing for creative applications such as seasonal fragrance combinations, brand storytelling through scent progression, or interactive experiences where each fragrance corresponds to a different aspect of the overall product message.

The method 200 can include a step 224 of curing the microencapsulated fragrance varnish 106. The microencapsulated fragrance varnish 106 can be cured using heat, UV light, air drying, or combinations thereof, as desired. The curing process can ensure proper adhesion to the substrate and optimal microcapsule stability. As described herein, the microencapsulated fragrance varnish 106 can require physical activation to release the fragrance, such that when the user scratches or rubs the treated area, the microcapsule can rupture, releasing the encapsulated fragrance 112 and creating the desired olfactory experience.

### EXAMPLES

The following examples demonstrate embodiments of the present disclosure in use. The examples are provided for illustrative purposes only and should not be construed as limiting the scope of the present disclosure. It will be appreciated by those skilled in the art that various modifications, alternatives, and variations of the examples can be made without departing from the spirit and scope of the present disclosure as defined by the appended claims.

In a first example, a marketing company receives an order for five hundred promotional scratch and sniff postcards featuring a new logo for a bakery and the scent of fresh-baked cookies. The production operator begins by loading cardstock substrate 102 into the digital printing system and preparing the digital artwork file that specifies the logo of the bakery, contact information, and the coordinates for a 6-square-inch scratch and sniff portion 120 positioned over an image of chocolate chip cookies. The operator selects a low odor UV ink for the base image 104 printing to ensure that no competing scents will interfere with the cookie fragrance experience. The digital printing system prints the full-color base image 104 onto each postcard substrate at 300 dots per inch, creating vibrant graphics that showcase the branding of the bakery and appetizing cookie imagery.

While the base image 104 is drying, the operator prepares the microencapsulated fragrance varnish 106 by measuring the appropriate amount of cookie-scented powder 116 containing microcapsules 110 and mixing it with clear varnish 118 using a tabletop mixer at 400 rpm for five minutes. The operator adjusts the concentration of scent compound 116 to achieve a medium fragrance intensity that will provide a noticeable but not overwhelming cookie scent when activated. The resulting mixture creates a smooth, transparent varnish with no visible agglomerations, and the operator verifies that the viscosity is within the acceptable range of 2,000 centipoise for optimal printing performance with the large orifice print head.

The operator loads the microencapsulated fragrance varnish 106 into the large orifice print head system, which features 20-micron diameter openings to accommodate the encapsulated fragrance particles without clogging. The digital printing system reads the coordinate data from the artwork file and begins applying the transparent varnish 118 precisely to the designated scratch and sniff portion 120 on each postcard, covering the chocolate chip cookie image area. The large orifice print head operates at 200 dots per inch resolution and applies the varnish at a production speed of 50 feet per minute, creating a uniform coating approximately 25 microns thick that preserves the visibility of the underlying cookie image while embedding thousands of fragrance microcapsules 110.

After printing, the postcards pass through a UV curing station that solidifies the varnish 106 and ensures optimal adhesion to the substrate 102 without damaging the encapsulated fragrance. The operator performs quality control checks by gently scratching a test area on several postcards, confirming that the cookie scent releases immediately upon activation and that the fragrance intensity matches the specified requirements. The completed scratch and sniff postcards are packaged for delivery to the bakery, where customers will be able to scratch the cookie image area and experience the enticing aroma of fresh-baked cookies, creating a memorable sensory connection with the brand of the bakery that other printed materials cannot provide.

In a second example, a manufacturer of car air fresheners receives an order for a custom air freshener package featuring a floral design with lavender scent activation. The production process begins with a cardboard backing substrate 102 that will serve as the package base with sufficient structural integrity to support both the base image printing and subsequent varnish application. The operator loads the cardboard substrate 102 in for the digital printing process and prepares the artwork file containing the floral graphics, product branding, and usage instructions, using low odor digital ink to ensure no interference with the intended lavender fragrance experience.

The digital printing system applies the full-color base image 104 onto each cardboard backing substrate 102, creating vibrant floral imagery that will appeal to consumers and clearly communicate the lavender scent promise. After the base image printing is complete and properly dried, the printed substrate 102 is fed through the digital printer equipped with the large orifice print head system for microencapsulated fragrance varnish 106 application. The operator has prepared the microencapsulated fragrance varnish by mixing lavender-scented powder containing microcapsules 110 with clear varnish using controlled mixing procedures to achieve the desired fragrance intensity. The large orifice print head applies the transparent microencapsulated fragrance varnish 106 to designated areas of the floral design, creating interactive scratch and sniff portions 120 that correspond to specific flower images on the package. The completed air freshener packages undergo UV curing to ensure proper adhesion and microcapsule stability, resulting in attractive retail packaging that allows the consumer to experience the actual lavender scent before purchase by scratching the designated floral areas.

In a third example, a greeting card company develops a birthday card featuring chocolate cake imagery where specific text elements will serve as interactive scratch and sniff portions 120. The manufacturer decides to integrate microencapsulated chocolate fragrance directly into the digital ink used for printing the base image 104, creating a dual-function printing material that delivers both visual content and scent release capability in a single printing operation. The production team identifies the text “Happy Birthday” as the primary scratch and sniff portion 120, determining that this celebratory message should carry the embedded chocolate fragrance to create a memorable sensory connection.

The scent-enhanced ink is prepared by incorporating microencapsulated chocolate fragrance materials directly into a brown-colored ink formulation, ensuring that the text color complements both the chocolate theme and the embedded fragrance content. The manufacturer selects the brown ink color specifically to reinforce the chocolate concept while maintaining the structural integrity of the microcapsules 110 during the printing process. The digital printing system applies the fragrance-enhanced brown ink exclusively to the “Happy Birthday” text elements, while using standard digital inks for all other graphic elements and text on the card. The targeted application ensures that only the designated text functions as an interactive scratch and sniff area, where the user can activate chocolate fragrance release by scratching or rubbing the birthday message itself. The concentration of scent compounds within the brown ink is carefully controlled to deliver appropriate fragrance intensity while maintaining text legibility and color quality. The finished greeting cards provide an integrated sensory experience where the celebratory message serves as both visual communication and interactive fragrance delivery, eliminating the need for separate designated scratch and sniff zones while creating a direct connection between the textual content and the olfactory experience.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method for digitally manufacturing a scratch and sniff portion on a substrate with microencapsulated fragrance varnish, comprising:
printing a base image on a substrate using an ink configured for a digital printing process;
identifying the scratch and sniff portion on the substrate for application of the microencapsulated fragrance varnish; and
applying the microencapsulated fragrance varnish to the scratch and sniff portion on the substrate using the digital printing process with a large orifice print head, the microencapsulated fragrance varnish requiring physical activation to release a fragrance therefrom.

2. The method of claim 1, wherein the base image is printed using a volatile organic compound ink.

3. The method of claim 1, wherein the large orifice print head comprises an opening from 15 microns to 25 microns in diameter.

4. The method of claim 1, wherein the microencapsulated fragrance varnish is transparent when applied to the substrate.

5. The method of claim 1, further including a step of preparing the microencapsulated fragrance varnish by mixing scent compound containing microcapsules with a clear varnish to form a homogeneous mixture.

6. The method of claim 5, wherein the step of preparing the microencapsulated fragrance varnish comprises:
selecting a fragrance;
selecting an encapsulation wall material;
emulsifying the fragrance in a solution containing the wall material at a mixing sheer rater configured to form an emulsion;
solidifying the microcapsule by drying to form the scent compound; and
mixing the scent compound into varnish to form the microencapsulated fragrance varnish.

7. The method of claim 6, wherein the step of solidifying the microcapsules includes spray drying, freeze-drying, or solvent evaporation.

8. The method of claim 1, wherein the scratch and sniff portion overlaps with a portion of the base image.

9. The method of claim 1, wherein the scratch and sniff portion entirely covers the base image.

10. The method of claim 1, wherein the scratch and sniff portion is spaced apart from the base image.

11. The method of claim 1, further including a step of applying a plurality of microencapsulated fragrance varnishes, each microencapsulated fragrance varnish having a different fragrance.

12. The method of claim 1, further including a step of adjusting a concentration of a scent compound in the microencapsulated fragrance varnish to control an intensity of the released fragrance, the scent compound including the fragrance.

13. The method of claim 1, further comprising curing the microencapsulated fragrance varnish after application using heat, UV light, or air drying.

14. A scratch and sniff product, comprising:
a substrate;
a base image digitally printed on the substrate using a digital ink; and
a microencapsulated fragrance varnish applied to a scratch and sniff portion on the substrate using a digital printing process with a large orifice print head, the microencapsulated fragrance varnish requiring physical activation to release a fragrance therefrom.

15. The scratch and sniff product of claim 14, wherein the microencapsulated fragrance varnish is transparent.

16. The scratch and sniff product of claim 14, wherein a scent compound includes a microcapsule including a fragrance encapsulated in an encapsulation wall material.

17. The scratch and sniff product of claim 16, wherein the encapsulation wall material includes a member selected from a group consisting of gelatin, alginate, and modified starch.

18. The scratch and sniff product of claim 14, wherein the scratch and sniff portion overlaps with a portion of the base image.

19. The scratch and sniff product of claim 14, wherein the scratch and sniff portion entirely covers the base image.

20. The scratch and sniff product of claim 14, wherein the scratch and sniff portion is spaced apart from the base image.
